(19) United States
(12) Patent Application Publication
(10) Pub. No.: US 2011/0302057 A1
(43) Pub. Date: Dec. 8, 2011

(54) Method and system for processing transactions over a distributed computer network

(76) Inventors: Jonathan Karon, Portland, OR (US); William Spazante, Pacific Grove, CA (US); Troy Baloca, San Jose, CA (US); Greg Shepard, Santa Cruz, CA (US)

(21) Appl. No.: 12/802,351

(22) Filed: Jun. 4, 2010

(51) Int. Cl. G06Q 40/00; G06Q 30/00

(52) U.S. Cl. 705/27.1; 705/30

(57) ABSTRACT

This invention relates to a method and system for processing transactions over a distributed computer network wherein proceeds from subscriber transactions are allocated among geographically diverse entities that may have dissimilar accounting, accrual and organizational structures.

### FIELD

This invention relates to the field of distributed computer systems and more specifically to a method and system for processing financial and/or ecommerce transactions in which proceeds and/or dividends associated with individual transactions are dynamically allocated between geo-spatially distinct organizations of different types such as profit and non-profit organizations as directed by each user who initiates a transaction. The invention provides a method and system for processing financial transactions wherein acquisition, allocation and accrual may be segregated and processed as partially taxable and non-taxable events to promote individual philanthropic or charitable contributions while simultaneously supporting the efforts to promote corporate responsibility.

### BACKGROUND

It has become increasingly important to consumers that products and/or services are provided by merchants and/or vendors who have demonstrated social responsibility. It has become increasingly popular for merchants and/or vendors that their products and/or services are produced from recycled or renewable materials or are manufactured using alternative energy sources. In the alternative, many merchants and/or vendors have become more involved in supporting charitable giving programs, openly support various non-profit organizations or may even sponsor their own socially accountable programs.

Many consumers base their purchasing decisions on the social accountability of a merchant and/or vendor and may elect to avoid merchants and/or vendors who are not perceived as being socially accountable. In addition, consumers within a “community of interest” frequently have a need and/or desire to inform others of emergent beneficiaries who may be in need of assistance. For example, natural disasters such as earthquakes, hurricanes or other catastrophic events may generate an immediate and unplanned intent among groups of interested individuals to provide support for the victims thereof and to communicate that intent within their “community of interest”.

Increasingly, interne based social networking services such as Linkedin, Twitter and Facebook are now virtual “communities of interest” wherein users of these services may promote and support any of a number of charitable or otherwise socially desirable causes that could have otherwise been neglected due to lack of funding, organization or any internal capacity for self-promotion. Many of these worthy endeavors previously failed due to an inability to achieve self-sustaining funding levels.

The invention presented herein provides a novel method and system for satisfying the desires of consumers to engage socially accountable vendors and/or merchants while simultaneously providing the ability to increase the exposure and funding levels of charitable or otherwise socially desirable causes that may not have survived without the capabilities of the method and system presented herein.

### SUMMARY

This invention provides a system for processing transactions in a distributed transaction processing system for subscribers to effect transactions with socially accountable merchants and/or vendors while simultaneously directing a portion of the proceeds from those transactions to beneficiaries designated by the subscriber. The method and system contemplate a social accounting system coupled to a vendor fulfillment system having a database of socially accountable merchants.

Subscriber initiated transactions are effected directly between a respective subscriber and at least one of the socially accountable merchants. A transaction processor in a social accounting system authenticates each respective subscriber as well as the socially accountable merchants listed in a vendor fulfillment system.

An accounting services system receives proceeds from each transaction and a payment system allocates a portion of the proceeds between any of a number of beneficiaries which may have distinct organizational and accounting structures.

### BRIEF DESCRIPTION OF THE DRAWINGS

FIG. 1 is a diagram of the architecture of the distributed transaction processing system of the present invention.

FIG. 2 is a cascading functional flow block diagram showing the basic operation of the distributed transaction processing system of FIG. 1.

FIG. 3 is a diagram showing the architectural hierarchy of the subsystems managed by the subscriber services server described in conjunction with FIG. 1.

FIGS. 4A-4D show the data schema used in the operation of the social accounting system described in conjunction with FIG. 1.

FIG. 5 is a system flow diagram showing the subscriber controls and data flow while initiating a transaction and designating a beneficiary in distributed transaction processing system of FIG. 1.

FIG. 6 depicts the system control and data flow 600 associated with processing, accounting and reconciliation of payments over distributed computer network 100.

FIG. 7 depicts the system control and data flow 700 associated with the distribution of payments to beneficiaries by accounting server 122 of social accounting system 102.

FIG. 8 shows the system flow and control 800 in which a subscriber may generate messages for advocating on behalf of their preferred beneficiaries.

### DETAILED DESCRIPTION OF THE INVENTION

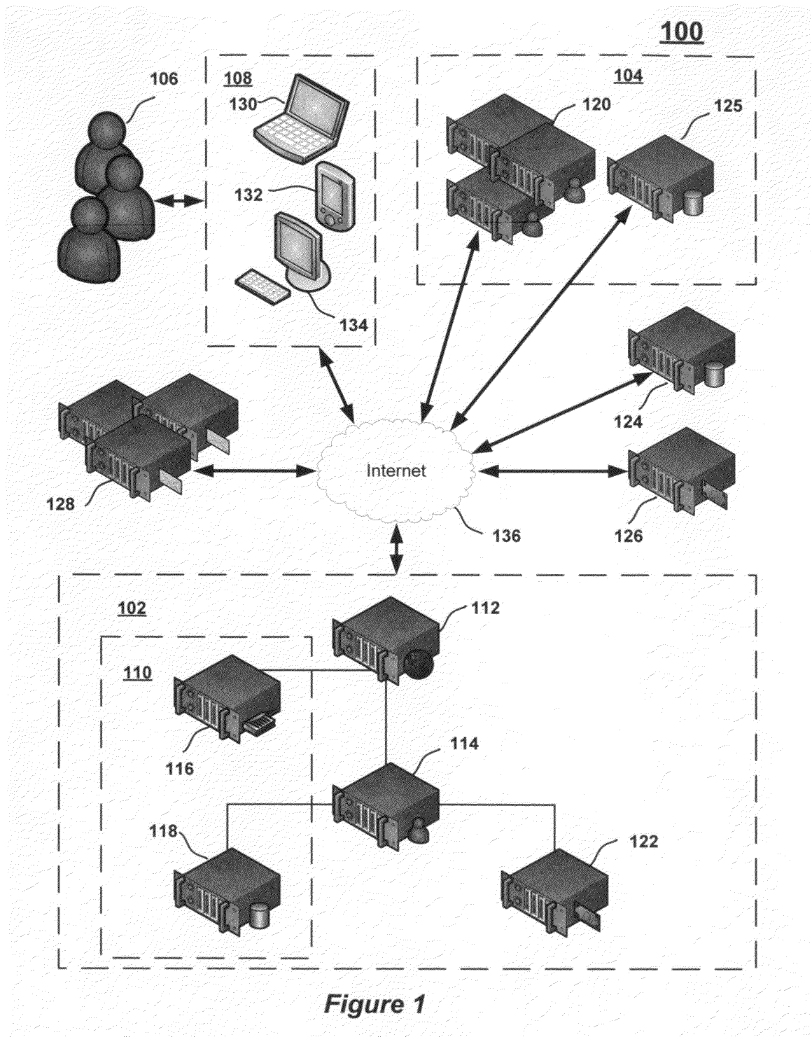

Referring to FIG. 1, system 100 comprises a social accounting system 102, coupled to a vendor fulfillment system 104, wherein subscribers 106 initiate transactions using any of a number of client devices 108 to effect transactions between respective subscribers 106 and socially responsible merchants within vendor fulfillment system 104.

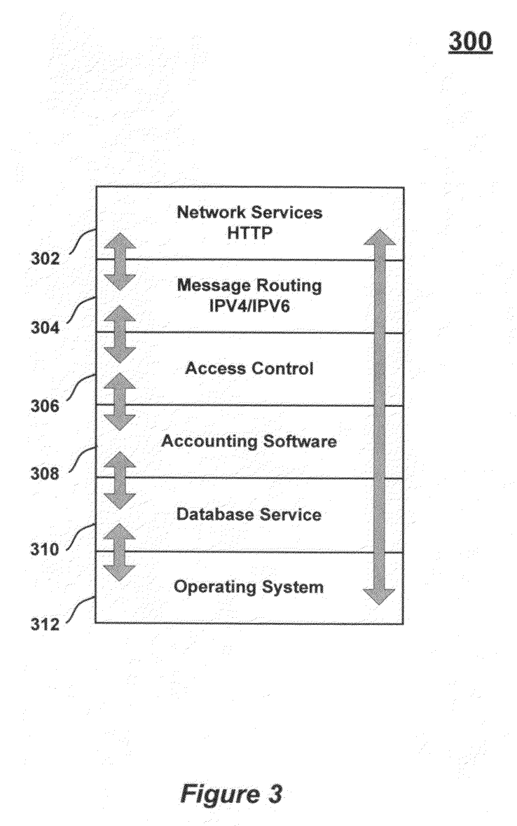

The overall operation of social accounting system 102 is controlled by subscriber services server 114. Subscriber services server 114 is an application server whose operation is further described in conjunction with FIGS. 3-8. Subscriber services server 114 may communicate with web server 112, database server 118, subscriber authentication server 116, and accounting server 122 via a conventional local area network (LAN) to coordinate and control the overall operation of social accounting system 102.

Subscriber services server 114 may communicate with vendor fulfillment system 104, beneficiary database server 124, payment distribution services 126 and subscriber communication services 128 through web server 112 which is adapted for communication via conventional wide-area network (WAN) connections such as those deployed over internet 136.

Respective subscribers 106 initiate transactions through social accounting system 102 through web server 112 which provides a variety of end-user services as further described herein. Upon establishing a connection with web server 112, subscriber services server 114 authenticates the subscriber with authentication server 116 to provide access to a database of social responsible merchants listed in database 118.

Those skilled in the art will appreciate that the table of socially responsible merchants maintained in database 118 maybe derived from a remote server hosting a service 125 such as popshops.com, linkshare.com, commissionjunction.com or any of a number of similar services. Database 118 further includes a table of beneficiaries which may be designated by a subscriber to receive a dividend or a portion of the proceeds from each transaction initiated by respective subscribers 106.

In one embodiment of the present invention, in the event a subscriber discovers a desired merchant and/or desired beneficiary is not previously listed in database 118, a subscriber may append beneficiary table 404 or merchant table 408 stored in database 118 to reflect their philanthropic intent.

Authenticated subscribers 106 select a socially responsible merchant listed in database 118 to directly initiate a merchant transaction with any of a number of merchant systems 120 to effect a transaction for the delivery of goods or services. Payment for the requested goods of services and fulfillment or delivery thereof is transmitted directly between authenticated subscribers 106 through any of the respective client devices 108 and the vendor fulfillment system 104.

Proceeds from each respective transaction are received by accounting server 122 from vendor fulfillment system 104 and distributed among designated beneficiaries listed in beneficiary database 124 through payment distribution service 126. A portion of the proceeds are retained within social accounting system 102 for costs, expenses and other accounting items associated with the operation and maintenance of social accounting system 102. Beneficiary database may be derived from any of a number of sources, including without limitation, publically available listings such as those provided by guidestar.org.

This invention uniquely provides a system and method for allocating and accounting proceeds from transactions among both profit and non-profit organizations enumerated in beneficiary database 124 through payment services 126 which may include services such as Paypal or PayQuicker.

This invention further provides the ability for a respective subscriber to designate beneficiaries of each transaction wherein if a desired beneficiary is not listed in beneficiary database 124, authenticated subscribers 106 may append database 118 to effect payment through payment service 126 to entities irrespective of organizational structure while accommodating the philanthropic intent of respective subscribers 106.

Authenticated subscribers 106 are provided the ability to communicate with other subscribers (or potential subscribers) through subscriber communication servers 128 to promote or advocate on behalf of charitable or otherwise socially desirable causes. In one embodiment of the invention, communication servers 128 may host various social networking services such as Twitter, Facebook, Linkedin or any of a number of other services adapted for communication between large groups.

Those skilled in the art will appreciate that the various servers and devices of distributed computer system 100 are adapted to send, receive and route network communications using conventional internet connections and protocols which may include HTTP, HTTPS, IPV4, IPV6, TCP/IP and/or any of a number of networking protocols adapted for data communication via the internet 136.

Those skilled in the art will further appreciate that the respective end-user devices 108 which may include a laptop computer 130, an internet enabled “smart phone” 132, or a conventional desktop computer system 134, each of which are shown by way of example and not limitation.

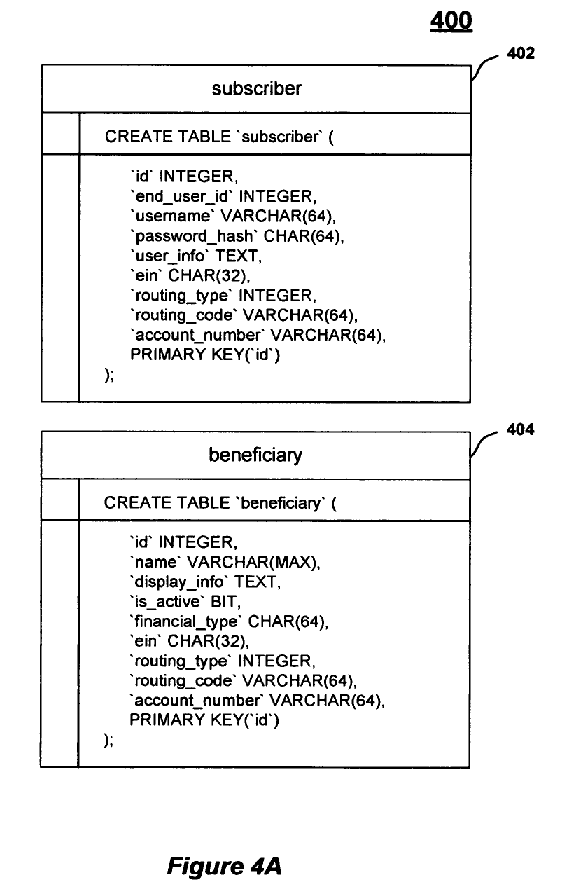

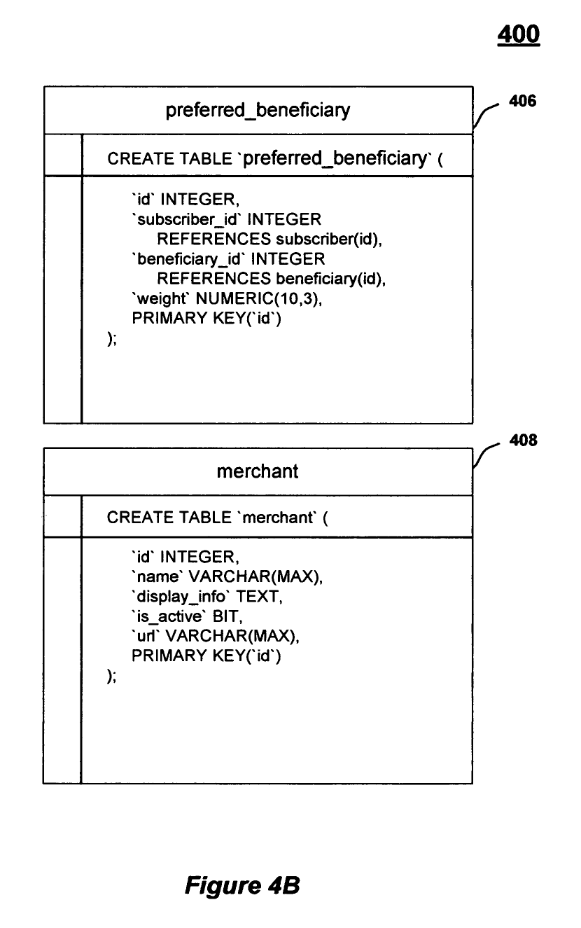

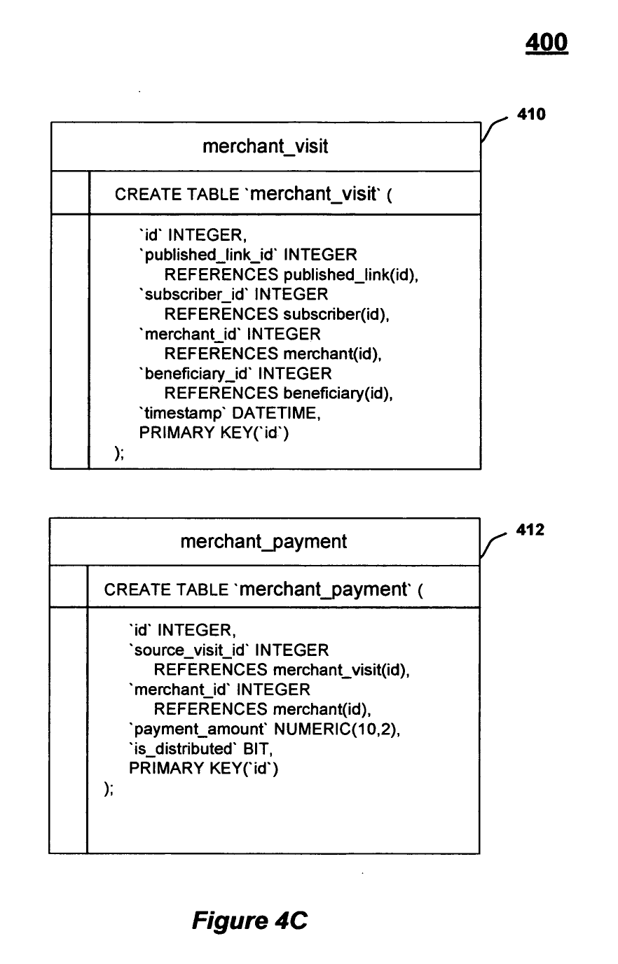

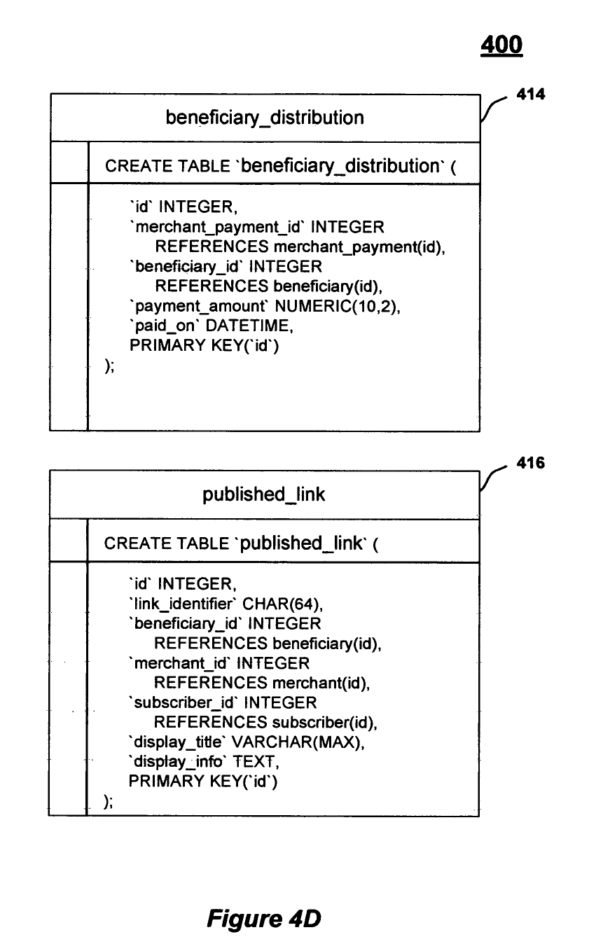

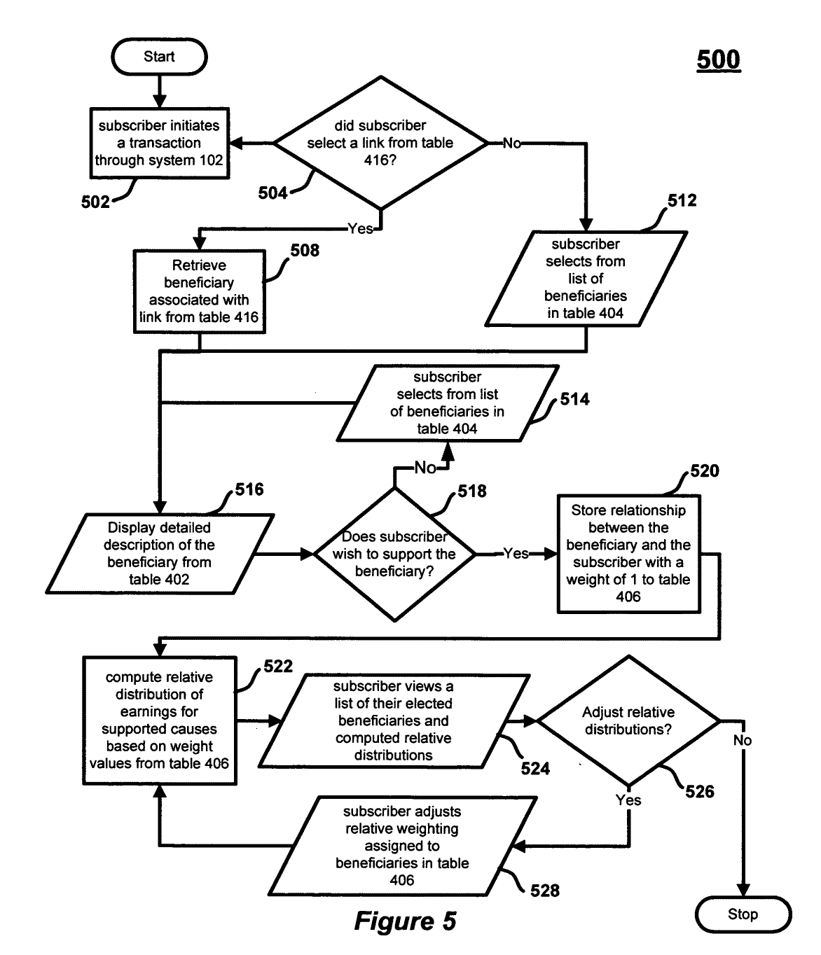

As noted above, social accounting system 102 includes a subscriber services server 114 which is an application server that coordinates the overall operation of distributed computer network 100 as defined by the API shown in FIG. 3, the schema shown in FIGS. 4A-4D, and the associated system flow diagrams shown in FIGS. 5-8.

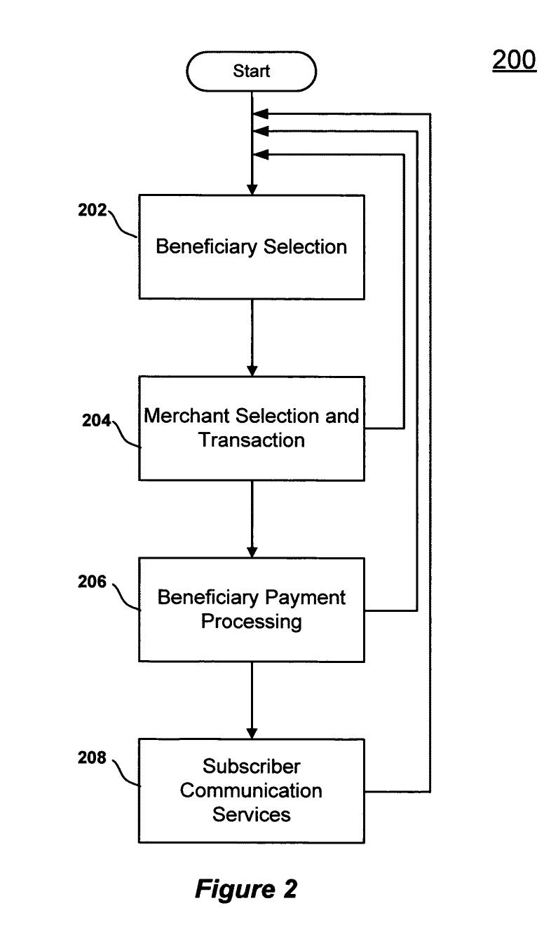

FIG. 2 is a recursive cascading functional flow block diagram showing the high level operation of the distributed transaction processing system of FIG. 1. This invention includes approximately five system partitions organized in a cascading structure, each of which is described in further detail herein. Each of the respective system partitions operates in conjunction with the relational database schema shown in FIGS. 4A-4D through the application programming interface implemented in subscriber services server 114.

When invoked, system module 202 provides system controls for selecting or designating one or more beneficiaries. The detailed operation of module 202 is described further in conjunction with FIG. 5.

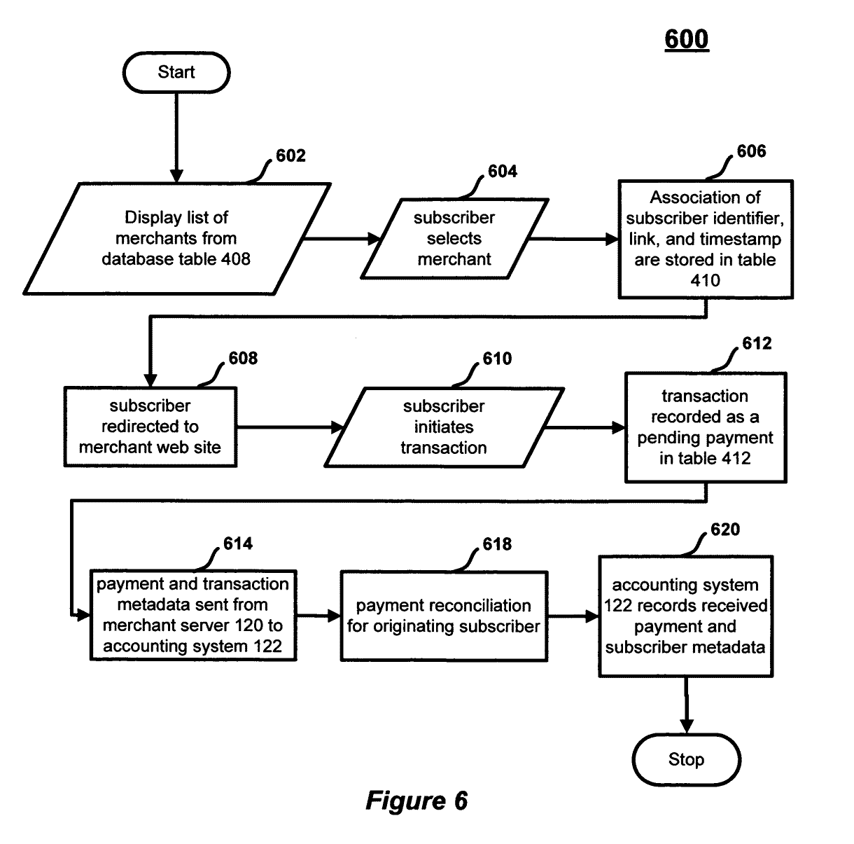

System module 204 provides system controls wherein a subscriber initiates a transaction with one or more socially accountable merchants and/or vendors listed in the database managed by social accounting system 102. The detailed operation of system module 204 is described further in conjunction with FIG. 6.

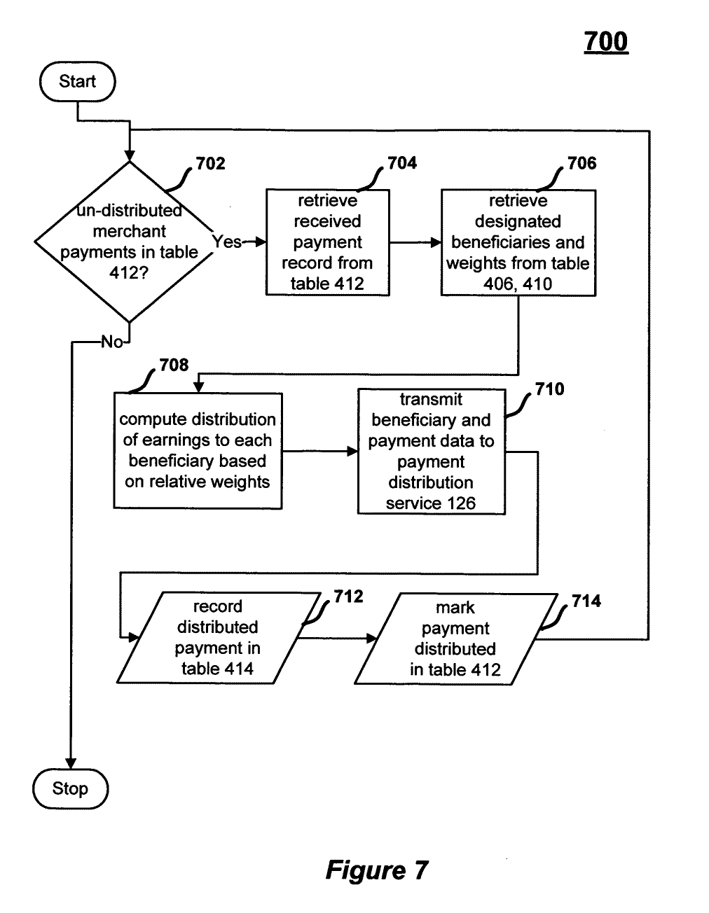

System module 206 provides system controls wherein a subscriber selects or designates one or more socially accountable merchants and/or vendors. The detailed operation of system module 206 is described further in conjunction with FIG. 7.

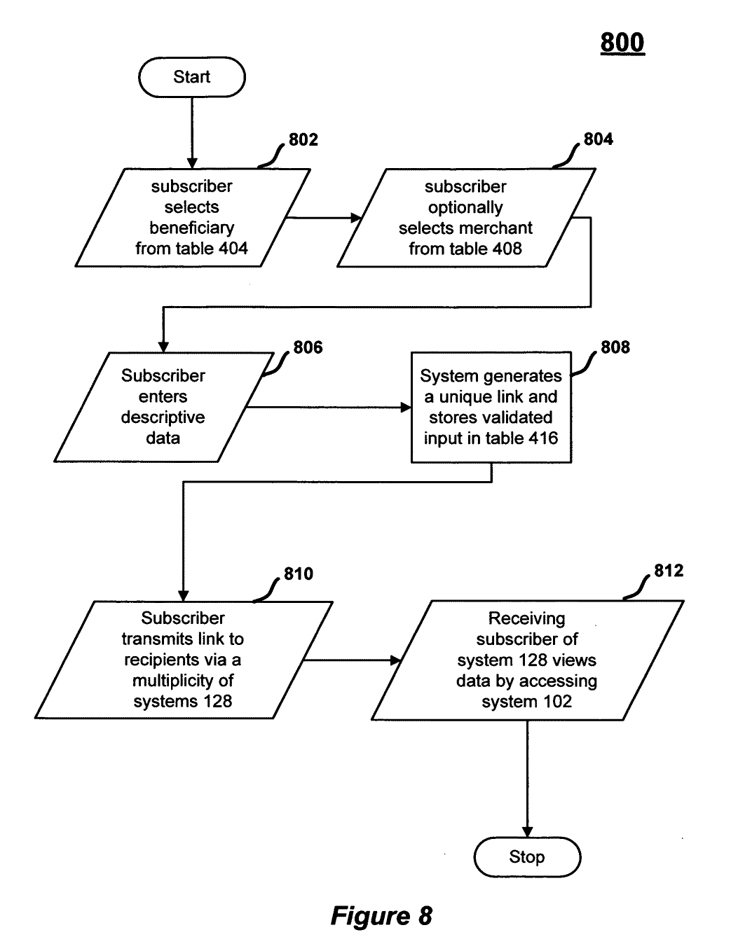

System module 208 provides system controls wherein a subscriber may advocate on behalf of their preferred beneficiaries through various social networking services. The detailed operation of system module 208 is described further in conjunction with FIG. 8.

The system returns to system module 202 upon completion of the tasks in system module 208, to recursively provides services to subscribers 106.

FIG. 3 is a diagram of the application program interface (API) 300 which is used to control the overall operation of the distributed computer network 100. The API is hosted in subscriber services server 114 within social accounting system 102 and operates in association with the schema depicted in FIGS. 4A-4D. API 300 includes application layer 302 which works in cooperation with message routing application layer 304, access control layer 306 which operate in cooperation with operating system layer 312 to provide subscriber network access and authentication to social accounting system 102 via the internet 136.

Upon authentication, subscribers utilize the system and method presented herein via the social accounting system 102 in accordance with accounting services 308 hosted on accounting server 122 as further described herein. The database service 310 is hosted on subscriber services server 114 and transaction processor 110 as further described in conjunction with FIGS. 4A-4D.

FIGS. 4A-4D show a pseudo-code depiction of a schema constructed in accordance with the requirements of the ISO SQL: 2003 standard published by ISO/IEC. Those skilled in the art will appreciate that the various tables shown in FIGS. 4A-4D provide a relational database wherein the naming conventions shown therein conform to ISO/IEC 9075:2003 which is available from the International Standards Organization at http://www.iso.org/.

Schema 400 defines operating modules 402-416 which are configured as tables within an ISO SQL: 2003 structure which is invoked in accordance with the system flow diagrams shown in FIGS. 5-8. In accordance with the nomenclature defined in ISO/IEC 9075:2003, a primary key is a direct reference to a defined field or variable within a table or data structure while a foreign key is a referential constraint between two tables. The referencing and referenced table may be in the same table which is referred to as a self-referencing or recursive foreign key. A table may include multiple foreign keys, and each foreign key may have a different referenced table. Therefore, cascading relationships can be established using foreign keys.

Subscriber table 402 stores essential information related to individual subscribers and includes unique fields for storing subscriber name, password, tax identification information and payment information including a subscribers preferred bank account number, bank routing number and routing type. Those skilled in the art will appreciate that accounting and payment processing may be implemented in accordance with the Automated Clearing House (ACH) payment processing regulations established by the National Clearing House Association (NACHA) and the United States Federal Reserve. Subscriber table 402 defines each respective subscriber as a “primary key” within the ISO SQL: 2003 structure.

Beneficiary table 404 stores essential information related to charitable or otherwise socially desirable beneficiaries as described herein and includes unique fields for storing beneficiary name, tax identification information and payment information including a beneficiaries preferred bank account number, bank routing number and routing type. Beneficiary table 404 further includes a field that identifies whether a particular beneficiary is presently active within social accounting system 102. Beneficiary table 404 defines each respective beneficiary as a “primary key” within the ISO SQL: 2003 structure.

Preferred_beneficiary table 406 stores essential information related to preferred beneficiaries as described herein and includes wherein a preferred beneficiary may be determined in accordance with user preference. Preferred_beneficiary table 406 defines unique fields for storing subscriber and beneficiary names and further includes a field that associates a weighting factor with each preferred beneficiary. Preferred_beneficiary table 406 defines each respective preferred beneficiary as a “primary key” within the ISO SQL: 2003 structure, but further includes “foreign key” references to subscriber table 402 and beneficiary table 404.

Merchant table 408 stores essential information related to merchants as described herein. Merchant table 408 defines unique fields for storing the identity “id” of each respective merchant and further includes a field that indicates whether respective merchants are presently active in the distributed computer network 102. Merchant table 408 defines each respective preferred merchant as a “primary key” within the ISO SQL: 2003 structure.

Merchant_visit table 410 stores essential information for tracking transactions between subscribers and merchants. Merchant_visit table 410 defines unique fields for the number of subscriber “visits” associated with each respective merchant and further includes a field that provides a timestamp associated with each of said “visits”. Merchant_visit table 410 defines each respective merchant “id” as a “primary key” within the ISO SQL: 2003 structure, but further includes “foreign key” references to subscriber table 402, beneficiary table 404, and merchant table 408.

Merchant_payment table 412 stores essential information related to payments associated with each transaction between respective subscribers and respective merchants. Merchant_visit table 410 defines unique fields for the number of subscriber “visits” associated with each respective merchant and further includes a field that provides a timestamp associated with each of said “visits”. Merchant_visit table 410 defines each respective merchant visit “id” as a “primary key” within the ISO SQL: 2003 structure, but further includes “foreign key” references to subscriber table 402, beneficiary table 404, and merchant table 408.

Beneficiary_distribution table 414 stores essential information related to distributions to beneficiaries associated with each merchant payment resulting from a transaction between respective subscribers and respective merchants. Beneficiary_distribution table 414 defines a unique field for the payment amount associated with each “distribution” and further includes a field that provides a timestamp associated with each of said “distributions”. Beneficiary_distribution table 414 defines each respective beneficiary distribution “id” as a “primary key” within the ISO SQL: 2003 structure, but further includes “foreign key” references to merchant_payment table 412 and beneficiary table 404, respectively.

Published_link table 416 contains fields for storing links associated with each respective subscriber, respective merchants and respective beneficiaries wherein such links may be hyperlinks as defined in accordance with the HTTP protocol. Published_link table 416 defines unique fields for the identification of beneficiaries, merchants, and subscribers which are defined as primary keys, each of which include foreign keys which reference tables 404, 408 and 402 within the ISO SQL: 2003 structure, and further includes fields for storing variables “display_title” and “display_info”.

Those skilled in the art will appreciate that tables 402-416 may be implemented as a SQL database hosted on database server 118 or distributed between servers 116-118 within transaction processor 110 wherein the information maintained in tables 402-416 is accessed and updated by subscriber services server 114 to control the overall operation of distributed computer network 100.

The overall operation of distributed computer network 100 as controlled by social accounting system 102 is depicted in further detail in conjunction with the system flow diagrams shown in FIGS. 5-8.

FIG. 5 shows the system control and data flow 500 associated with subscriber initiated transactions and the designation of beneficiaries over distributed computer network 100. A subscriber initiates a transaction with social accounting system 102 in process step 502. Decision step 504 queries table 416 to determine whether the subscriber selected a link previously stored in table 416. If so, process step 508 retrieves the beneficiary link from table 416. Otherwise, in input step 512, the subscriber selects from the list of beneficiaries enumerated in table 404.

Output step 516 sends display data to the subscriber based on detailed beneficiary information stored in table 402. Decision step 518 queries whether the subscriber intends to proceed with the selected beneficiary. If not, input step 514 accepts an alternate beneficiary selection listed in table 404 from the subscriber. Otherwise, process step 520 stores the relationship between the beneficiary and subscriber along with a weighting variable in table 406.

Process step 522 then determines the relative distribution of proceeds between selected beneficiaries on the basis of the weighting variable stored in table 406. The results of process step 522 are displayed to the subscriber in output step 524. Decision step 526 determines whether the subscriber intends to adjust the relative distribution of proceeds among beneficiaries. If so, input step 528 allows the subscriber to adjust the relative distribution of proceeds among beneficiaries. Otherwise, the system control and data flow 500 returns to process subsequent transactions.

FIG. 6 depicts the system control and data flow 600 associated with processing, accounting and reconciliation of payments over distributed computer network 100. Upon invocation, output step 602 displays the list of merchants maintained in table through any of client devices 108. A respective subscriber 104 then selects a merchant in input step 604. In process step 606, table 410 is updated with associated subscriber information such as the subscriber identification, link and timestamp described above.

Process step 608 then re-directs the subscriber to a respective vendor server associated with a selected vendor and the subscriber initiates a transaction in input step 610. Process step 612 then updates table 412 to record the transaction as a pending payment. Payment and transaction metadata are sent from merchant server 120 to accounting system 122 in process step 614 and the subscriber payment is reconciled in process step 618. The accounting system 122 then records the received payment and subscriber metadata in table 412.

FIG. 7 depicts the system control and data flow 700 associated with the distribution of payments to beneficiaries by accounting server 122 of social accounting system 102. Upon invocation, decision step 702 determines whether undistributed merchant payments are indicated in table 412. If not, system control and data flow 700 returns until invoked for subsequent transactions.

While decision 702 determines un-distributed payments are indicated in table 412, process step 704 retrieves the payment record from table 412 and process step 706 retrieves associated beneficiary information stored in tables 406, 410. A weighted beneficiary distribution is computed in process step 708 and beneficiary and payment data is transmitted or communicated to payment distribution service 126. Table 414 is then updated to record respective distributed payments in output step 712 and table 412 is updated in output step 714 to indicate the payment has been distributed. When decision 702 determines un-distributed payments are not indicated in table 412, system control and data flow 700 returns until invoked for subsequent transactions.

FIG. 8 shows the system flow and control 800 in which a subscriber may generate messages for advocating on behalf of their preferred beneficiaries through various social media as described above. Upon invocation, a respective subscriber selects a beneficiary from table 404 in input step 802. The subscriber may optionally designate a preferred merchant from table 408 in input step 804. The subscriber then enters a narrative or descriptive information in input step 806. A unique link and validated information input in steps 802-806 is stored in table 416 in process step 808. In output step 810, the validated information is transmitted to designated recipients through subscriber communication servers 128. The transmitted information may then be received and viewed by the designated recipients in output step 812 and the system flow and control returns to process subsequent subscriber messages.

The techniques described herein may be implemented in hardware, software, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, desktop computers, any of a number of server types or other electronic units designed to perform the functions described herein, or a combination thereof.

For software implementations, the techniques described herein may be implemented with modules (e.g., procedures, functions, and so on) that perform the functions described herein. The software codes may be stored in a memory unit and executed by processors, controllers, computers and/or servers described herein. The memory unit may be implemented within the processor or external to the processor, in which case it can be communicatively coupled to the processor via various means as is known in the art.

The description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

Even though the invention is described above with reference to an example according to the accompanying drawings, it is clear that the invention is not restricted thereto and can be modified in several ways within the scope of the appended claims.

1. A system for processing transactions in a distributed transaction processing system, comprising:
(a) a social accounting system coupled to a vendor fulfillment system having a plurality of merchants listed in a database of socially accountable merchants;
(b) at least one client device coupled to said social accounting system for conducting end-user initiated transactions between at least one subscriber and at least one of said socially accountable merchants;
(c) a transaction processor in said social accounting system for authenticating end-user initiated transactions and the socially accountable merchants listed in said vendor fulfillment system;
(d) an accounting services system for receiving proceeds from said end-user initiated transactions transmitted from the vendor fulfillment system to the social accounting system; and
(e) a payment system for allocating said proceeds from the end-user initiated transaction between a plurality of beneficiaries having distinct accounting structures.

2. The system of claim 1 wherein said beneficiaries may be assigned hierarchical categories and classifications by said social accounting system.

3. The system of claim 1 wherein said subscribers selects said beneficiaries by category or classification.

4. The system of claim 1 further including a communication system to enable said subscriber to publish a list of preferred beneficiaries to additional subscribers.

5. A method for processing transactions in a distributed transaction processing system, comprising the steps of:
(a) Initiating a transaction between a subscriber and a socially accountable merchant wherein a subscriber received goods or services from said merchant and said transaction generates proceeds;
(b) transmitting the proceeds from said socially accountable merchant to a social accounting system; and
(c) distributing a portion of said proceeds to designated beneficiaries as directed by said subscriber.

6. The method of claim 5 wherein said beneficiaries may be assigned hierarchical categories and classifications.

7. The method of claim 6 wherein subscribers select beneficiaries by category or classification.

8. The method of claim 5 wherein said subscriber publishes a list of preferred beneficiaries to additional subscribers.

9. The method of claim 5 wherein unauthenticated end-users may initiate transactions through said distributed transaction processing system to perform some or all of the actions performed by subscribers in the system.

10. The method of claim 5 wherein each socially responsible merchant may publish one or more digital coupons offering incentives to purchase one or more products, subscribers select a coupon, and the coupon is associated with a link transmitted by the subscriber to end-users.

11. A distributed transaction processing system for processing transactions between subscribers and vendors and distributing associated proceeds among beneficiaries, said system comprising:
a) a wide area network;
b) a social accounting system coupled to said wide area network through a web server, said social accounting system including a transaction processing system, an application server and an accounting server;
c) one or more client devices coupled to said social accounting system through said wide-area network for receiving input and displaying output to said respective subscribers;
d) one or more vendor servers coupled to said social accounting system and said client devices through said wide-area network;
e) communication servers coupled to said social accounting system through said wide area network;
f) a beneficiary server coupled to said social accounting system for storing a list of qualified beneficiaries; and
g) a payment system coupled to said social accounting system through said wide area network.

12. The distributed transaction processing system of claim 11 wherein said client devices are adapted for effecting transactions with said vendor servers, wherein said transactions generate proceeds.

13. The system of claim 12 wherein a portion of said proceeds are distributed to said social accounting system.

14. The system of claim 11 wherein said application server is adapted for receiving transaction information from said vendor servers and associating said transaction information with a list of beneficiaries in said transaction processing system.

15. The system of claim 14 wherein said application server is adapted for generating payment information through said accounting server on the basis of said transaction information associated in said transaction processing system.

16. The system of claim 15 wherein said application server communicates said generated payment information to said payment system to effect distribution of at least a portion of said generated proceeds to a least one of said beneficiaries.

17. The system of claim 11 wherein said communication servers are adapted for communicating messages from said client devices and transmitting said messages to one or more social networks.

18. The system of claim 1 wherein said wide-area network may be implemented over the internet.

19. The system of claim 11 wherein said vendor servers comprise systems adapted for effecting e-commerce transactions, wherein said client devices place orders and tender payments for goods and/or services through said vendor servers.

20. The system of claim 11 wherein said client devices are adapted for communication using any of a variety of conventional internet protocols.

21. The system of claim 14 wherein said list of beneficiaries may be designated by any of said client devices.
